(19) United States
(12) Patent Application Publication
(10) Pub. No.: US 2016/0249136 A1
(43) Pub. Date: Aug. 25, 2016

(54) LOUDSPEAKER AND LOUDSPEAKER DRIVER

(71) Applicant: DEXIN CORPORATION, New Taipei City (TW)

(72) Inventor: SANG-HYUN KIM, NEW TAIPEI CITY (TW)

(21) Appl. No.: 14/628,228

(22) Filed: Feb. 21, 2015

(51) Int. Cl. H04R 7/16; H04R 9/06; H04R 1/28

(52) U.S. Cl. CPC H04R 7/16; H04R 1/2803; H04R 9/06

(57) ABSTRACT

A loudspeaker is provided. The loudspeaker includes a housing, a conical frame, a diaphragm, an inner surround portion, a magnetic assembly, a voice coil, and a double-roll surround structure. The conical frame has an upper portion formed with an opening The diaphragm is located at the upper portion and circumscribed by the opening. The edge of the diaphragm and the edge of the conical frame defining the opening are connected by the inner surround portion. The magnetic assembly is disposed on a lower portion of the conical frame. The voice coil is below the diaphragm and corresponds to the magnetic assembly. The edge of the conical frame and the housing are connected by the double-roll surround structure.

### BACKGROUND OF THE INVENTION

1. Field of the Invention

The present disclosure relates to a loudspeaker and a loudspeaker driver; in particular, to a loudspeaker and a loudspeaker driver having a double-roll surround structure.

2. Description of Related Art

Small loudspeakers are lightweight, easy to install and cheap, and are therefore commonly used in the market. However, the small size of a small loudspeaker compromises the ability of the loudspeaker to produce bass sound, which is related to the magnitude of vibration of the diaphragm and the loudspeaker driver. As shown in FIG. 1 and FIG. 2, a loudspeaker driver A100 of a small loudspeaker A300 can be suspended on a housing A200 by an outer surround portion A70, for increasing the magnitude of vibration of the loudspeaker driver A100 and its diaphragm A20, for obtaining a bass effect. However, when the diaphragm A20 vibrates by a great magnitude such that the loudspeaker unit A100 on the housing A200 moves along an axial direction, irregular movements, such as undesired horizontal movements, often result. Since a motion strictly along the axial direction cannot be realized, the vibration of the diaphragm A20 is uneven and sound is distorted and unclear, even if a stiffer outer surround portion A70 is used.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is to provide a loudspeaker and a loudspeaker driver, which can resist irregular movement for preventing distortion and loss of clarity of sound and preserving a preferred bass effect.

In order to achieve the aforementioned objects, the present disclosure provides a loudspeaker driver adaptable to be mounted to a housing. The loudspeaker driver includes a conical frame, a diaphragm, an inner surround portion, a magnetic assembly, a voice coil, and a double-roll surround structure. The upper portion of the conical frame is formed with an opening The diaphragm is positioned at the opening of the conical frame. The inner surround portion is connected between the periphery of the diaphragm and the edge of the opening of the conical frame. The magnetic assembly is disposed in the lower portion of the conical frame. The voice coil is positioned below the diaphragm and corresponds to the magnetic assembly. The double-roll surround structure is connected between the periphery of the conical frame and the housing.

In summary of the above, the loudspeaker driver of the present disclosure can be suspended on the housing through the double-roll surround structure for increasing the magnitude of vibration of the loudspeaker driver and its diaphragm, thereby increasing the bass effect of the loudspeaker. Additionally, when the diaphragm undergoes a piston-like motion and creates vibration of a great magnitude, such that the loudspeaker driver suspended on the housing is driven to move along an axial direction, the design of the double-roll surround structure resists irregular movements for preventing distortion and loss of clarity of sound, and preserving a preferred bass effect.

### BRIEF DESCRIPTION OF THE DRAWINGS

FIG. 1 shows a cross-sectional view of a conventional loudspeaker driver;

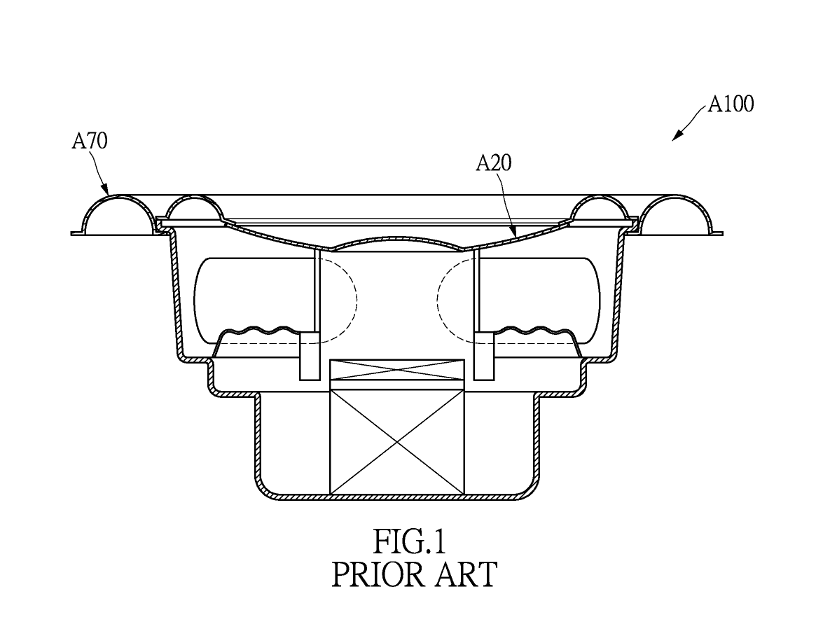

FIG. 2 shows a cross-sectional view of a conventional loudspeaker;

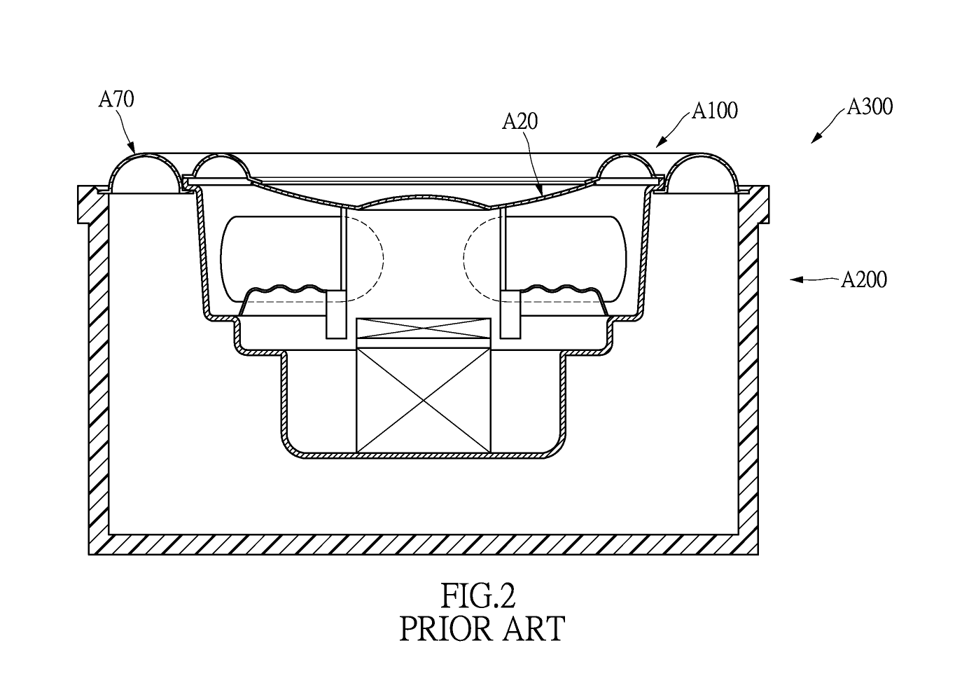

FIG. 3 shows a top view of a loudspeaker driver according to the present disclosure;

FIG. 4 shows a perspective of a loudspeaker driver according to the present disclosure;

FIG. 5 shows a perspective view from another angle of a loudspeaker driver according to the present disclosure;

FIG. 6 shows a cross-sectional view of a loudspeaker driver according to the present disclosure;

FIG. 7 shows a cross-sectional view of a loudspeaker according to the present disclosure; and

FIG. 8 shows a view indicating motion of a loudspeaker according to the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

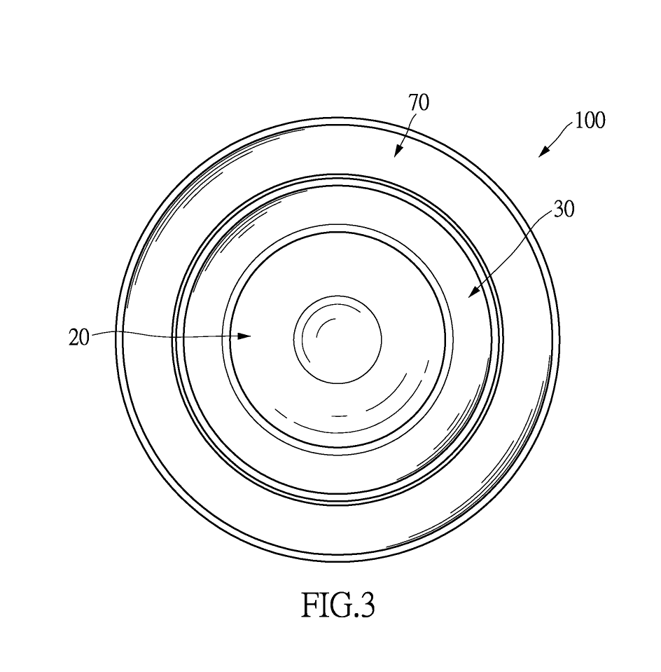

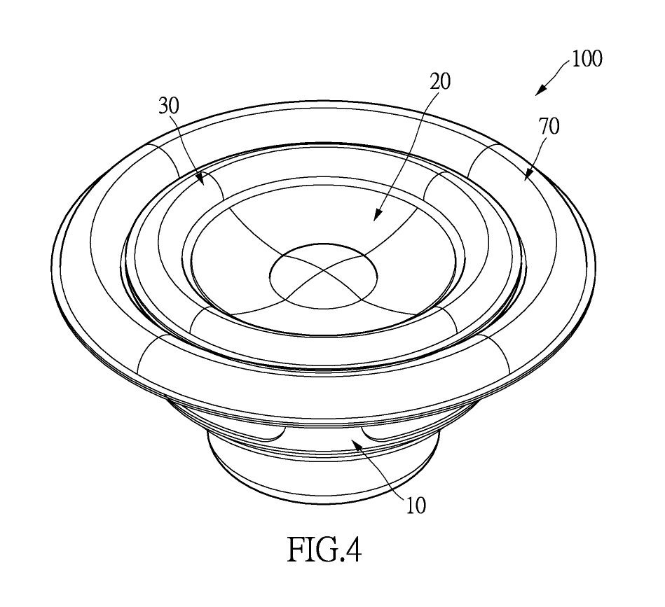

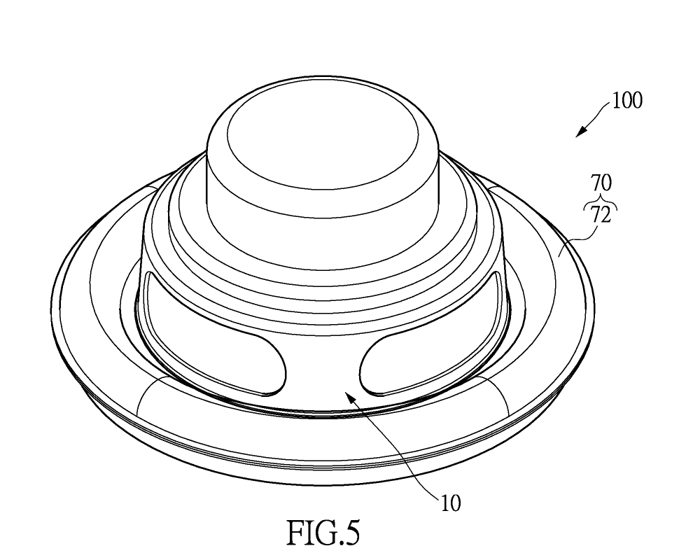

Referring to FIG. 3 to FIG. 7, the present disclosure provides a loudspeaker and a loudspeaker driver. The loudspeaker driver 100 is adaptable to be mounted on a housing 200. The housing 200 can be a sound box. The material of the sound box can be wood, plastic, or a combination of materials, and is not limited to the above. The structure of the housing 200 is also not limited, and can be modified according to need. In the present embodiment, the loudspeaker driver 100 is for example a loudspeaker driver of a small loudspeaker, and comprises a conical frame 10, a diaphragm 20, an inner surround portion 30, a magnetic assembly 40, a voice coil 50, and a double-roll surround structure 70.

The conical frame 10 is made of for example metal, and is the main structure of the loudspeaker driver 100. The contour of the conical frame 10 is substantially conical, but is not limited thereto, and can be modified according to need. Additionally, the conical frame 10 can be partitioned into an upper portion 11 and a lower portion 12. The upper portion 11 of the conical frame 10 is formed with an opening 111.

The diaphragm 20 can be a sound basin made of paper pulp for example, but can also be made of cloth, silk, canvas, ceramic, synthetic fiber, metal, plastic, or polymer, but is not limited thereto. The diaphragm 20 is substantially conical and is positioned at the opening 111 of the conical frame 10. In other embodiments, the diaphragm 20 can be planar.

The inner surround portion 30 can be made of silicon, cloth, rubber, or foam for example, and is connected between the periphery of the diaphragm 20 and the edge of the opening 111 of the conical frame 10, such that the diaphragm 20 can be connected to the conical frame 10 through the inner surround portion 30. Of particular note, the present embodiment shows only one strip of inner surround portion 30. In another embodiment not shown in the figures, an additional strip of inner surround portion can be adhered under the inner surround portion 30. By attaching two strips of surround portions together, they are less easily deformed during vibration.

The magnetic assembly 40 is disposed in the lower portion 12 of the conical frame 10. The magnetic assembly 40 can be for example inside magnetic, including a washer and two magnetic units of different poles. The magnetic units can be yoke iron or magnets. The magnetic assembly 40 can also be outside magnetic. Additionally, the void coil 50 is positioned below the diaphragm 20 and sleeves the magnetic assembly 40. By this configuration, when electric current passes through the voice coil 50, electromagnetic effects with the magnetic assembly 40 cause the voice coil 50 connected to the diaphragm to vibrate up and down, driving the diaphragm 20 to also move up and down for producing sound. Of particular note, a person skilled in the art can freely implement the arrangement of the magnetic assembly 40 and the voice coil 50 such that the voice coil 50 and the magnetic assembly 40 can produce an electromagnetic effect therebetween. The arrangement of the magnetic assembly 40 and the voice coil 50 inside the conical frame 10 is not limited to that of the present embodiment.

The loudspeaker driver 100 can further comprise an elastic wave member 60 disposed in the conical frame 10 and surrounding the voice coil 50, for supporting the voice coil 50 when the voice coil 50 is driven to move. Of particular note, the arrangement of the elastic wave member 60 is not limited to that of the present embodiment.

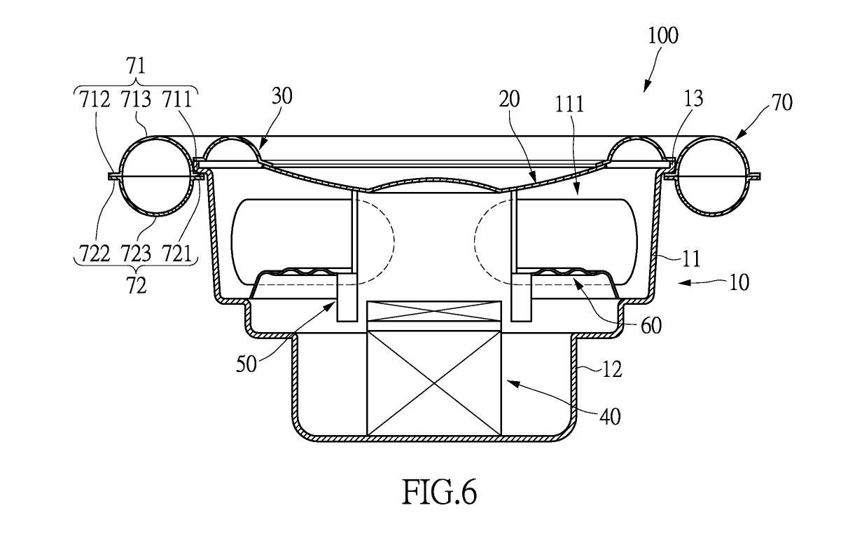

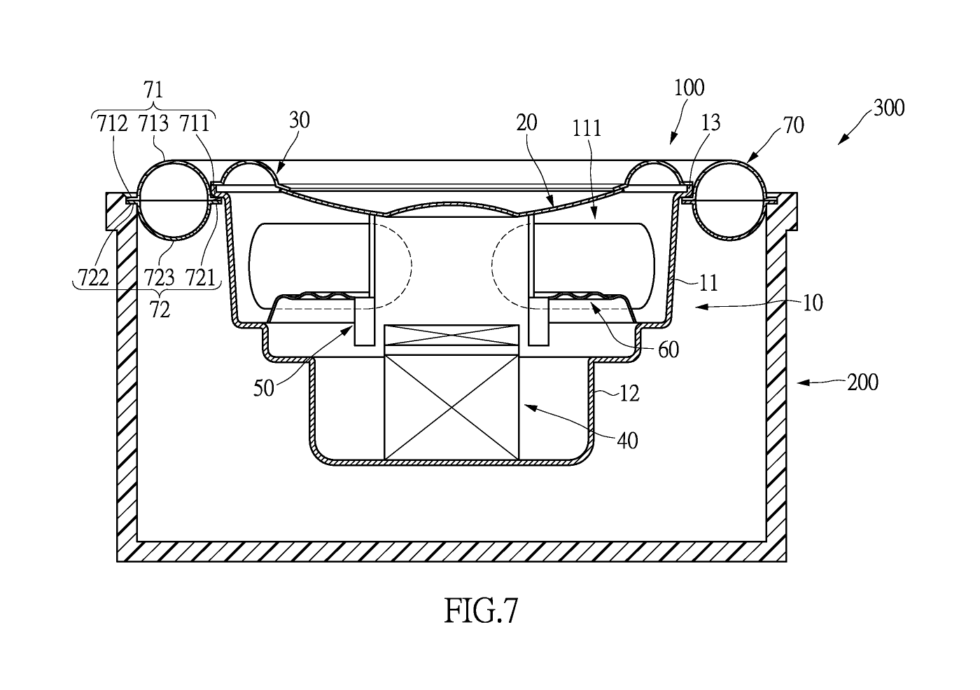

One edge of the double-roll surround structure 70 is connected to the periphery of the conical frame 10, and another edge of the double-roll surround structure 70 can be connected to the housing 200 (as shown in FIG. 6). Namely, when the double-roll surround structure 70 is connected between the conical frame 10 and the housing 200, the loudspeaker driver 100 is connected to the housing 200 through the double-roll surround structure 70 and forms a loudspeaker 300 (as shown in FIG. 7).

Specifically, the double-roll surround structure 70 includes a first outer surround side 71 and a second outer surround side 72. The first outer surround side 71 and the second outer surround side 72 are made of for example silicon, cloth, rubber, or foam. Preferably, the first outer surround side 71 and the second outer surround side 72 are made of the same material. Additionally, the first outer surround side 71 and the second outer surround side 72 are both annular and aligned on top of each other. Specifically, the first outer surround side 71 has a first inner bend portion 711, a first outer bend portion 712, and a first arc portion 713 connected between the first inner bend portion 711 and the first outer bend portion 712. Similarly, the second outer surround side 72 has a second inner bend portion 721, a second outer bend portion 722, and a second arc portion 723 connected between the second inner bend portion 721 and the second outer bend portion 722. Additionally, the structure of the first outer surround side 71 and the structure of the second outer surround side 72 can be identical or not identical. For example, the length of the first inner bend portion 711 and the length of the second inner bend portion 721 can be the same or not the same. In more detail, the first inner bend portion 711 and the second inner bend portion 721 adhere to each other, the first outer bend portion 721 and the second outer bend portion 722 adhere to each other, the first arc portion 713 concaves upward, and the second arc portion 723 concaves downward. Namely, the first arc portion 713 and the second arc portion 723 concaves toward opposite directions. In further detail, an upper surface of the first inner bend portion 711 adheres to an annular protruding portion 13 formed at an outer edge of the conical frame 10, a lower surface of the second outer bend portion 722 adheres to an inner edge of the housing 200 such that the loudspeaker driver 100 is suspended on the housing 200.

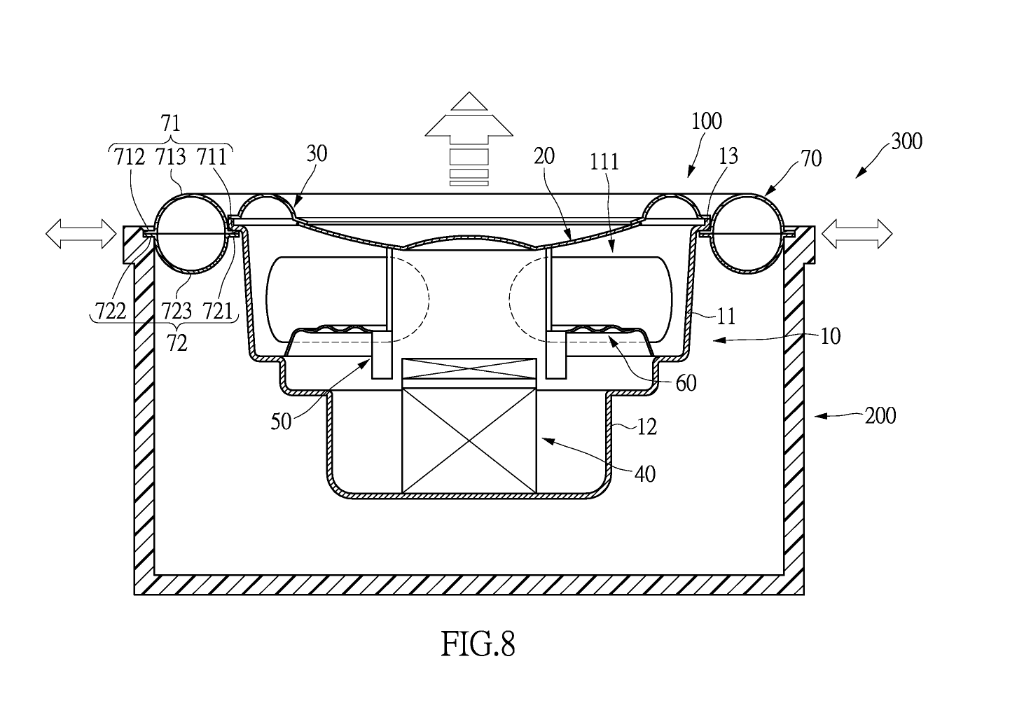

Therefore, the loudspeaker driver 100 of the present embodiment can be suspended on the housing 200 through the design of the double-roll surround structure 70, for increasing the magnitude of vibration of the loudspeaker driver 100 and the diaphragm 20, thereby increasing the bass effect of the loudspeaker 300. Additionally, when the diaphragm 20 undergoes a piston-like motion and creates vibration of a great magnitude, such that the loudspeaker driver 100 suspended on the housing 200 is driven to move along an axial direction, the design of the double-roll surround structure 70 resists irregular movements, such as horizontal movement shown by horizontal arrows in FIG. 8, for preventing distortion and loss of clarity of sound, and preserving a preferred bass effect.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A loudspeaker driver adaptable to a housing, comprising:
a conical frame having an upper portion formed with an opening;
a diaphragm positioned at the opening of the conical frame;
an inner surround portion connected between a periphery of the diaphragm and an edge of the opening of the conical frame;
a magnetic assembly disposed in a lower portion of the conical frame;
a voice coil positioned under the diaphragm and corresponding to the magnetic assembly; and
a double-roll surround structure having an edge for connecting to an outer edge of the conical frame and another edge for connecting to the housing.

2. The loudspeaker driver according to claim 1, wherein the double-roll surround structure includes a first outer surround side and a second outer surround side, and the first outer surround side and the second outer surround side are annular and aligned.

3. The loudspeaker driver according to claim 2, wherein the first outer surround side has a first inner bend portion, a first outer bend portion, and a first arc portion connected between the first inner bend portion and the first outer bend portion; and the second outer surround side has a second inner bend portion, a second outer bend portion, and a second arc portion connected between the second inner bend portion and the second outer bend portion.

4. The loudspeaker driver according to claim 3, wherein the first inner bend portion and the second inner bend portion are adhered to each other, the first outer bend portion and the second outer bend portion are adhered to each other, and the first arc portion and the second arc portion concave toward opposite directions.

5. The loudspeaker driver according to claim 3, wherein an upper surface of the first inner bend portion and an annular protruding portion formed on an outer edge of the conical frame adhere to each other, a lower surface of the second outer bend portion and an inner edge of the housing adhere to each other.

6. A loudspeaker, comprising:
a housing; and
a loudspeaker driver including:
a conical frame having an upper portion formed with an opening;
a diaphragm positioned at the opening of the conical frame;
an inner surround portion connected between a periphery of the diaphragm and an edge of the opening of the conical frame;
a magnetic assembly disposed in a lower portion of the conical frame;
a voice coil positioned under the diaphragm and corresponding to the magnetic assembly; and
a double-roll surround structure connected between an outer edge of the conical frame and the housing.

7. The loudspeaker according to claim 6, wherein the double-roll surround structure includes a first outer surround side and a second outer surround side, and the first outer surround side and the second outer surround side are annular and aligned.

8. The loudspeaker according to claim 7, wherein the first outer surround side has a first inner bend portion, a first outer bend portion, and a first arc portion connected between the first inner bend portion and the first outer bend portion; and the second outer surround side has a second inner bend portion, a second outer bend portion, and a second arc portion connected between the second inner bend portion and the second outer bend portion.

9. The loudspeaker according to claim 8, wherein the first inner bend portion and the second inner bend portion are adhered to each other, the first outer bend portion and the second outer bend portion are adhered to each other, and the first arc portion and the second arc portion concave toward opposite directions.

10. The loudspeaker according to claim 8, wherein an upper surface of the first inner bend portion and an annular protruding portion formed on an outer edge of the conical frame adhere to each other, a lower surface of the second outer bend portion and an inner edge of the housing adhere to each other.
